(19) United States
(12) Patent Application Publication
(10) Pub. No.: US 2011/0144277 A1
(43) Pub. Date: Jun. 16, 2011

(54) USE OF SILICON-CONTAINING PRECURSOR COMPOUNDS OF AN ORGANIC ACID AS A CATALYST FOR CROSS-LINKING FILLED AND UNFILLED POLYMER COMPOUNDS

(75) Inventors: Kerstin Weissenbach, Hillsborough, NJ (US); Aristidis Ioannidis, Rheinfelden (DE); Bastian Bielawski, Rheinfelden (DE)

(73) Assignee: Evonik Degussa GmbH, Essen (DE)

(21) Appl. No.: 13/058,290

(22) PCT Filed: Jul. 9, 2009
(86) PCT No.: PCT/EP2009/058718

§ 371 Date: Feb. 9, 2011

(30) Foreign Application Priority Data
Sep. 9, 2008 (DE) 102008041919.2

(51) Int. Cl. B01J 31/02; C08F 8/00; B32B 1/08

(52) U.S. Cl. 525/288; 502/158; 556/438; 428/36.9

(57) ABSTRACT

The invention relates to the use of a silicon-containing precursor compound of an organic acid, particularly an olefinic silicon-containing precursor compound of an organic acid and/or of a tetracarboxyl silane, for the production of unfilled and/or filled polymer compounds, polymers, or filled plastics, such as granules or finished products, made from thermoplastic base polymers and/or monomers and/or prepolymers of the thermoplastic base polymers. A finished product is an item, such as a molded body, particularly a cable, hose, or pipe. The invention further relates to a master batch comprising the silicon-containing precursor compound.

The invention relates to the use of a silicon-containing precursor compound of an organic acid, in particular an olefinic silicon-containing precursor compound of an organic acid, and/or of a tetracarboxysilane, for the production of unfilled and/or filled compounded polymer materials, polymers, or filled plastics, such as granules or finished products, made of thermoplastic parent polymers and/or of monomers and/or prepolymers of the thermoplastic parent polymers. A finished product is a product such as a molding, in particular a cable, hose, or pipe. The invention further relates to a masterbatch comprising the silicon-containing precursor compound.

It is known that filled and unfilled compounded polymer materials, in particular polyethylene (PE) and copolymers thereof, can be produced by using organotin compounds or aromatic sulfonic acids (Borealis) Ambicat®) as silanol condensation catalysts for the crosslinking of silane-grafted or silane-copolymerized polyethylenes. A disadvantage of the organotin compounds is their significant toxicity, while the sulfonic acids are notable for their pungent odor, which continues through all stages of the process into the final product. The compounded polymer materials crosslinked by sulfonic acids are generally not suitable for use in the food-and-drinks sector or in the drinking-water-supply sector, for example for production of drinking-water pipes, because of reaction byproducts. Dibutyltin dilaurate (DBTDL) and dioctyltin dilaurate (DOTL) are conventional tin-based silanol condensation catalysts, and act as catalyst by way of their coordination sphere.

It is known that moisture-crosslinkable polymers can be produced by grafting silanes onto polymer chains in the presence of free-radical generators, where moisture-crosslinking is carried out in the presence of the abovementioned silane hydrolysis catalysts and/or silanol condensation catalysts, after the shaping process. Moisture-crosslinking of polymers using hydrolyzable unsaturated silanes is practiced worldwide for the production of cables, pipes, foams, etc. Processes of this type are known as the sioplas process (DE 19 63 571 C3, DE 21 51 270 C3, U.S. Pat. No. 3,646,155) and the monosil process (DE 25 54 525 C3, U.S. Pat. No. 4,117,195). Whereas the monosil process adds the crosslinking catalyst before the first step of processing is complete, the sioplas process delays addition of the crosslinking catalyst to the subsequent step, the shaping step. Another possibility is to copolymerize vinyl-functional silanes together with the monomers and/or prepolymers directly to give the parent polymer, or to couple these onto polymers by grafting on the polymer chains.

EP 207 627 discloses further tin-containing catalyst systems and, with these, modified copolymers based on the reaction of dibutyltin oxide with ethylene-acrylic acid copolymers. JP 58013613 uses Sn(acetyl)₂ as catalyst, and JP 05162237 teaches the use of carboxylates of tin, of zinc, or of cobalt together with hydrocarbon groups as silanol condensation catalysts, e.g. dioctyltin maleate, monobutyltin oxide, dimethyloxybutyltin, or dibutyltin diacetate. JP 3656545 uses zinc and aluminum soaps for crosslinking, examples being zinc octylate and aluminum laurate. JP 1042509 likewise discloses the use of organic tin compounds for the crosslinking of silanes, but also discloses alkyl titanic esters based on titanium chelate compounds.

The fatty acid reaction products of functional trichlorosilanes have been well known since the 1960s, in particular as lubricant additives. DE 25 44 125 discloses the use of dimethyldicarboxysilanes as lubricant additive in the coating of magnetic tapes. In the absence of strong acids and bases, the compound has sufficient resistance to hydrolysis.

It is an object of the present invention to develop novel silane hydrolysis catalysts and/or silanol condensation catalysts which do not have the above-mentioned disadvantages of the known catalysts from the prior art, and which can preferably undergo a homogenization process or dispersion process with silane-grafted polymers, silane-copolymerized polymers, or monomers or prepolymers, or generally with thermoplastic polymers. It is preferable that the silane hydrolysis catalysts and/or silanol condensation catalysts are liquid or waxy to solid, and/or have been applied to a carrier material, or encapsulated.

The object is achieved via the inventive use corresponding to the features of claim 1, and also via the masterbatches as claimed in claims 12 and 13. Preferred embodiments are found in the dependent claims and in the description.

Surprisingly, it has been found that silicon-containing precursor compounds of an organic acid can be used as silane hydrolysis catalyst and/or silanol condensation catalyst, in particular as catalyst for the crosslinking of silanols, or with other functional groups capable of condensation in substrates, for example with OH-Si or HO-substrate. A general requirement placed upon the precursor compound is that it is hydrolyzable, in particular in the presence of moisture, and thus can liberate the free organic acid, in particular under the conditions of the monosil process and/or sioplas process. In the invention, the silicon-containing precursor compound of the organic acid is hydrolyzable when heat is supplied, preferably in the molten state in the presence of moisture, and liberates the organic acid completely or at least to some extent.

In another aspect of the invention, the use of the silicon-containing precursor compound of an organic acid can take place in a monosil process, in a sioplas process, or in a copolymerization process. In particular, it can be used for grafting onto an olefinic polymer, or for copolymerization with monomers, with prepolymers, and/or with thermoplastic parent polymers. Surprisingly, it has moreover been found that the silicon-containing precursor compound of an organic acid can also act as adhesion promoter, in particular for the formation of Si—O—Si bonds, or else Si—O-substrate.

The inventive use of the precursor compound as catalyst permits simple and cost-effective conversion of thermoplastic parent polymers, or monomers, and/or prepolymers of the parent polymers to compounded polymer materials, without the abovementioned disadvantages, such as toxicity and odor impairment, of the catalysts of the prior art. Another factor, dependent on use, is that there is then overall no liberation of alcohols during the production of compounded polymer materials or of polymers.

The silicon-containing precursor compound in the invention can be a carboxysilane, in particular an olefinic carboxysilane, and/or a tetracarboxysilane. The carboxysilane which is the silicon-containing precursor compound of an organic acid can be present in the liquid or preferably in the solid phase, and thereby becomes preferably inert to hydrolysis by atmospheric moisture. The olefinic carboxysilane in the invention is what is known as an all-in-one-package, since it can be copolymerized or grafted and can simultaneously act as adhesion promoter and/or silane hydrolysis catalyst and/or silanol condensation catalyst. The onset of the hydrolysis to give the organic acid preferably does not occur until heat and moisture are supplied.

In the invention, the at least one silicon-containing precursor compound of an organic acid corresponds to the general formula I and/or II

(A)_{z}SiR²ₓ(OR¹)_{4-z-x} (I)

(R¹O)_{3-y-u}(R²)ᵤ(A)_{y}Si-A-Si(A)_{y}(R²)ᵤ(OR¹)_{3-y-u} (II)
where, mutually independently, z is 0, 1, 2, or 3, x is 0, 1, 2, or 3, y is 0, 1, 2, or 3, and u is 0, 1, 2, or 3, with the proviso that in formula I z+x is smaller than or equal to (≦) 3, and in formula II y+u is independently smaller than or equal to (≦) 2,
A is mutually independently in formula I and/or II a monovalent olefin group,
and A in the form of a divalent moiety in formula II is a divalent olefin group,
R¹ corresponds, mutually independently, to a carbonyl-R³ group, where R³ corresponds to a substituted or unsubstituted hydrocarbon moiety, in particular having from 1 to 45 carbon atoms, and
R² corresponds, mutually independently, to a substituted or unsubstituted hydrocarbon group.

It is preferable that no alcohol is then liberated when at least one silicon-containing precursor compound of an organic acid, for example of the general formula I, where z=1, 2, or 3, and/or II, where y=0, 1, 2, or 3, and/or where z=0 and OR¹ corresponds to an unsaturated carboxylate moiety, in particular to a tetracarboxysilane, is grafted onto a parent polymer or is copolymerized with a monomer and/or prepolymer of the parent polymer, if appropriate in the presence of a free-radical generator, or is mixed with an appropriate carboxy-substituted silane-grafted parent polymer and, if appropriate, after the shaping process, preferably with supply of heat, acts as catalyst to bring about crosslinking in the presence of moisture. The grafting or copolymerization can also take place in the presence of an organofunctional silane compound, for example an unsaturated alkoxysilane of the general formula III.

In the formula I, it is preferable that z=1 and x=0, or z=0 and x=1 for the tricarboxysilanes and/or that for the tetracarboxysilanes z=0 and x=0, or that for dicarboxysilanes z=1 and x=1.

A is preferably mutually independently in formula I and/or II a monovalent olefin group, particular examples being
(R⁹)₂C═C(R⁹)-Mₖ-, in which R⁹ are identical or different, and R⁹ is a hydrogen atom or a methyl group or a phenyl group, the group M is a group from —CH₂—, —(CH₂)₂—, —(CH₂)₃—, —O(O)C(CH₂)₃—, or —C(O)O—(CH₂)₃—, k is 0 or 1, examples being vinyl, allyl, 3-methacryloxypropyl, and/or acryloxypropyl, n-3-pentenyl, n-4-butenyl, or
isoprenyl, 3-pentenyl, hexenyl, cyclohexenyl, terpenyl, squalanyl, squalenyl, polyterpenyl, betulaprenoxy, cis/trans-polyisoprenyl, or
R⁸—F_{g}—[C (R⁸)═C(R⁸)—C(R⁸)═C(R⁸)]ᵣ—F_{g}—, in which R⁸ are identical or different, and R⁶ is a hydrogen atom or an alkyl group having from 1 to 3 carbon atoms, or an aryl group, or an aralkyl group, preferably a methyl group or a phenyl group, groups F are identical or different, and F is a group from —CH₂—, —(CH₂)₂—, —(CH₂)₃—, —O(O)C(CH₂)₃—, or —C(O)O—(CH₂)₃—, r is from 1 to 100, in particular 1 or 2, and g is 0 or 1,
and in formula II, A is, in the form of a divalent olefin moiety in formula II, examples being the corresponding alkenylenes, such as 2-pentenylene, 1,3-butadienylene, iso-3-butenylene, pentenylene, hexenylene, hexenedienylene, cyclohexenylene, terpenylene, squalanylene, squalenylene, polyterpenylene, cis/trans-polyisoprenylene.

It is preferable that R¹ in formula I and/or II corresponds mutually independently to a carbonyl-R³ group, i.e. a —(CO)R³ group (—(C═O)—R³), so that —OR¹ is —O(CO)R³, where R³ corresponds to an unsubstituted or substituted hydrocarbon moiety (HC moiety), in particular having from 1 to 45 carbon atoms, preferably having from 4 to 45 carbon atoms, in particular having from 6 to 45 carbon atoms, preferably having from 6 to 22 carbon atoms, particularly preferably having from 6 to 14 carbon atoms, with preference having from 8 to 13 carbon atoms, and in particular to a linear, branched, and/or cyclic unsubstituted and/or substituted hydrocarbon moiety, and particularly preferably to a hydrocarbon moiety of a natural or synthetic fatty acid, and in particular R³ in R¹ is, mutually independently, a saturated HC moiety using —CₙH₂ₙ₊₁, where n=4 to 45, examples being —C₄H₉, —C₅H₁₁, —C₆H₁₃, —C₇H₁₅, —C₈H₁₇, —C₉H₁₉, —C₁₀H₂₁, —C₁₁H₂₃, —C₁₂H₂₅, —C₁₃H₂₇, —C₁₄H₂₉, —C₁₅H₃₁, —C₁₆H₃₃, —C₁₇H₃₅, —C₁₈H₃₇, —C₁₉H₃₉, —C₂₀H₄₁, —C₂₁H₄₃, —C₂₂H₄₅, —C₂₃H₄₇, —C₂₄H₄₉, —C₂₅H₅₁, —C₂₆H₅₃, —C₂₇H₅₅, —C₂₈H₅₇, —C₂₉H₅₉, or else preferably an unsaturated HC moiety, examples being —C₁₀H₁₉, —C₁₅H₂₉, —C₁₇H₃₃, —C₁₇H₃₃, —C₁₉H₃₇, —C₂₁H₄₁, —C₂₁H₄₁, —C₂₁H₄₁, —C₂₃H₄₅, —C₁₇H₃₁, —C₁₇H₂₉, —C₁₇H₂₉, —C₁₉H₃₁, —C₁₉H₂₉, —C₂₁H₃₃ and/or —C₂₁H₃₁. The composition can likewise use the relatively short-chain HC moieties R³, examples being —C₄H₉, —C₃H₇, —C₂H₅, —CH₃ (acetyl) and/or R³═H (formyl). However, because of the low hydrophobicity of the HC moieties, the composition is generally based on compounds of the formula I and/or II in which R¹ is a carbonyl-R³ group selected from the group of R³ having an unsubstituted or substituted hydrocarbon moiety having from 4 to 45 carbon atoms, in particular having from 6 to 22 carbon atoms, preferably having from 8 to 22 carbon atoms, particularly preferably having from 6 to 14 carbon atoms, or with preference having from 8 to 13 carbon atoms.

R² in formula I and/or II is mutually independently a hydrocarbon group, in particular a substituted or unsubstituted linear, branched, and/or cyclic alkyl, alkenyl, alkylaryl, alkenylaryl, and/or aryl group having from 1 to 24 carbon atoms, preferably having from 1 to 18 carbon atoms, and in particular having from 1 to 3 carbon atoms in the case of alkyl groups. Particularly suitable alkyl groups are ethyl groups, n-propyl groups, and/or isopropyl groups. Suitable substituted hydrocarbons are in particular halogenated hydrocarbons, examples being 3-halopropyl, such as 3-chloropropyl or 3-bromopropyl groups, where these are, if appropriate, accessible to nucleophilic substitution or else can be used in PVC.

It is therefore preferably also possible to use silicon-containing precursor compounds of an organic acid of the general formula I and/or II which correspond to alkyl-substituted di- or tricarboxysilanes where z=0 and x=1 or 2. Examples here are methyl-, dimethyl-, ethyl-, or methylethyl-substituted carboxysilanes based on capric acid, myristic acid, oleic acid, or lauric acid.

Carbonyl-R³ groups are the acid moieties of the organic carboxylic acids, an example being R³—(CO)—, where these in the form of carboxy groups in accordance with the formulae have bonding to the silicon Si—OR¹, as set out above. The acid moieties of the formula I and/or II can generally be obtained from naturally occurring or synthetic fatty acids, examples being the saturated fatty acids valeric acid (pentanoic acid, R³═C₄H₉), caproic acid (hexanoic acid, R³═C₅H₁₁), enanthic acid (heptanoic acid, R³═C₆H₁₃), caprylic acid (octanoic acid, R³═C₇H₁₅) , pelargonic acid (nonanoic acid, R³═C₈H₁₇), capric acid (decanoic acid, R³═C₉H₁₉), lauric acid (dodecanoic acid, R³═C₉H₁₉), undecanoic acid (R³═C₁₀H₂₃) , tridecanoic acid (R³═C₁₂H₂₅) myristic acid (tetradecanoic acid, R³═C₁₃H₂₇) pentadecanoic acid (R³═C₁₄H₂₉) palmitic acid (hexadecanoic acid, R³═C₁₅H₃₁) margaric acid (heptadecanoic acid, R³═C₁₆H₃₃), stearic acid (octadecanoic acid, R³═C₁₇H₃₅), nonadecanoic acid (R³═C₁₈H₃₇), arachic acid (eicosanoic/icosanoic acid, R³═C₁₉H₃₉), behenic acid (docosanoic acid, R³═C₂₁H₄₃), lignoceric acid (tetracosanoic acid, R³═C₂₃H₄₇), cerotinic acid (hexacosanoic acid, R³═C₂₅H₅₁), montanic acid (octacosanoic acid, R³═C₂₇H₅₅), and/or melissic acid (triacontanoic acid, R³═C₂₉H₅₉), and also the short-chain unsaturated fatty acids, such as valeric acid (pentanoic acid, R³═C₄H₉), butyric acid (butanoic acid, R³═C₃H₇), propionic acid (propanoic acid, R³═C₂H₅), acetic acid (R³═CH₃), and/or formic acid (R³═H), and can be used as silicon-containing precursor compound of the formula I and/or II of the otherwise purely organic silanol condensation catalysts.

It is however preferable, in the formula I and/or II, to use fatty acids having a hydrophobic HC moiety, where these are sufficiently hydrophobic, do not exhibit any unpleasant odor after liberation, and do not exude from the polymers produced. An HC moiety is sufficiently hydrophobic if the acid is dispersible in the polymer or in a monomer or prepolymer. By way of example, said exudation restricts the possible use of relatively high concentrations of stearic acid and palmitic acid in the silicon-containing precursor compounds of an organic acid. By way of example, at a concentration above a value as low as about 0.01% by weight of the liberated stearic acid or palmitic acid, based on the overall constitution of the polymer, a waxy exudation is observed on the polymers produced. If, therefore, the corresponding stearates and/or palmitates of the silicon-containing precursor compound are used, the only factor requiring attention is that the concentration of corresponding liberated acid is sufficiently low. Preferred acid moieties in the formulae I and/or II derive from acids such as the following, which can be used with advantage: capric acid, lauric acid, and myristic acid, or else behenic acid.

The naturally occurring or synthetic unsaturated fatty acids can similarly preferably be converted to the precursor compounds of the formula I and/or II. They can simultaneously perform two functions, firstly serving as silane hydrolysis catalyst and/or as silanol condensation catalyst, and, by virtue of their unsaturated hydrocarbon moieties, participating directly in the free-radical polymerization reaction. Preferred unsaturated fatty acids are sorbic acid (R³═C₅H₇), undecylenic acid (R³═C₁₀H₁₉), palmitoleic acid (R³═C₁₅H₂₉), oleic acid (R³═C₁₇H₃₃) elaidic acid (R³═C₁₇H₃₃), vaccenic acid (R³═C₁₉H₃₇), icosenoic acid (R³═C₂₁H₄₁), cetoleic acid (R³═C₂₁H₄₁), erucic acid (R³═C₂₁H₄₁), nervonic acid (R³═C₂₃H₄₅) linoleic acid (R³═C₁₇H₃₁), alpha-linolenic acid (R³═C₁₇H₂₉), gamma-linolenic (R═C₁₇H₂₉), linolenic acid arachidonic acid (R³═C₁₉H₃₁), timnodonic acid (R³═C₁₉H₂₉), clupanodonic acid (R³═C₂₁H₃₃), ricinoleic acid (12-hydroxy-9-octadecenoic acid (R³═C₁₇H₃₃), and/or cervonic acid (R³═C₂₁H₃₁). Precursor compounds of the formula I and/or II containing at least one oleic acid (R³═C₁₇H₃₃) moiety are particularly preferred.

Other advantageous acids from which the precursor compounds of the formula I and/or II having R³—COO or R¹O can be produced are glutaric acid, lactic acid (R¹ being (CH₃)(HO)CH—), citric acid (R¹ being HOOCCH₂C(COOH)(OH)CH₂—), vulpinic acid, terephthalic acid, gluconic acid, and adipic acid, where it is also possible that all of the carboxy groups have been Si-functionalized, benzoic acid (R¹ being phenyl), nicotinic acid (vitamin B3, B5). However, it is also possible to use the natural or synthetic amino acids, in such a way that R¹ corresponds to appropriate moieties such as those deriving from tryptophan, L-arginine, L-histidine, L-phenylalanine, or L-leucine, where L-leucine can be used with preference. It is also correspondingly possible to use the corresponding D-amino acids or a mixture of L- and D-amino acids, or an acid such as D[(CH₂)_{d})COOH]₃, where D=N, P, and d is independently from 1 to 12, preferably 1, 2, 3, 4, 5, or 6, where the hydroxy group of each carboxylic acid function can independently have been Si-functionalized.

It is therefore also possible to use corresponding compounds of the formula I and/or II based on moieties of said acids as silane hydrolysis catalyst and/or silanol condensation catalyst.

The silicon-containing precursor compound of an organic acid is in particular active in hydrolyzed form as silane hydrolysis catalyst and/or silanol condensation catalyst by way of the liberated organic acid, and is also itself suitable in hydrolyzed or nonhydrolyzed form for grafting on a polymer and/or copolymerization with a parent polymer, or with polymer/monomer, or prepolymer, or for crosslinking, for example in the form of adhesion promoter. In hydrolyzed form, the silanol compound formed contributes to crosslinking by means of resultant Si—O—Si siloxane bridges and/or Si—O-substrate or, respectively, carrier material, during the condensation reaction. Said crosslinking can use other silanols, siloxanes, or can generally use functional groups which are present on substrates, on fillers, and/or on carrier materials and which are suitable for the crosslinking reaction. Preferred fillers and/or carrier materials are therefore aluminum hydroxides, magnesium hydroxides, fumed silica, precipitated silica, silicates, and also other fillers and carrier materials mentioned below.

Very particularly preferred precursor compounds are vinylsilane trimyristate, vinylsilane trilaurate, vinylsilane tricaprate, and also corresponding allylsilane compounds of the abovementioned acids, and/or silane tetracarboxylates Si(OR¹)₄, examples being silane tetramyristate, silane tetralaurate, silane tetracaprate, or a mixture of said compounds. Certain amounts of vinylsilane tristearate, vinylsilane tripalmitate, alkylsilane tristearate, and/or alkylsilane tripalmitate can advantageously be used. The amounts used of silane stearates and/or silane palmitates should preferably be such that no more than 0.05% by weight, preferably from 0.01% by weight to 0% by weight, in particular from 0.01% to less than 0.001% by weight, of liberated acid, such as stearic acid or palmitic acid, is present in the overall constitution in % by weight of the resultant compounded polymer material or polymer.

Particularly preferred silicon-containing precursor compounds used are always those in which the acid or one of the organic acids has at least one hydrophobic group which permits solvation or dispersibility in respect of the plastic. These are in particular long-chain, branched or cyclic, nonpolar, in particular unsubstituted hydrocarbon moieties, in particular having from 6 to 22 carbon atoms, preferably having from 8 to 14 carbon atoms, particularly preferably having from 8 to 13 carbon atoms, having at least one carboxylic acid group. Preferred substituted hydrocarbon moieties that can be used are halogen-substituted HC moieties.

For the purposes of the present invention, it is preferable that the silicon-containing precursor compound I and/or II is also or as an alternative used for grafting onto a polymer and/or for copolymerization with a monomer, prepolymer, or parent polymer, and subsequent moisture-crosslinking.

The production of the carboxysilanes has long been known to the person skilled in the art. By way of example, U.S. Pat. No. 4,028,391 discloses processes for their production in which chlorosilanes are reacted with fatty acids in pentane. U.S. Pat. No. 2,537,073 discloses another process. The acid can, for example, be heated directly in a nonpolar solvent, such as pentane, with trichlorosilane or with a functionalized trichlorosilane, at reflux, to give the carboxysilane. In an example for production of tetracarboxysilanes, tetrachlorosilane is reacted with the corresponding acid in a suitable solvent (Zeitschrift für Chemie (1963), 3(12), 475-6). Other processes relate to the reaction of the salts or anhydrates of the acids with tetrachlorosilane or with functionalized trichloro-silanes.

Organic acids are carboxylic acids which have no sulfate groups or sulfonic acid groups, and in particular they are organic acids corresponding to R³—COOH; the anhydrides, esters, or salts of these organic acids can also be regarded as silicon-free precursor compound, and they particularly preferably have a long-chain, nonpolar, in particular substituted or unsubstituted hydrocarbon moiety, where the hydrocarbon moiety can be saturated or unsaturated, for example where R³ is from 1 to 45 carbon atoms, in particular having from 4 to 45 carbon atoms, preferably having from 8 to 45 carbon atoms, in particular having from 6 to 22 carbon atoms, preferably having from 8 to 22 carbon atoms, particularly preferably having from 6 to 14 carbon atoms, with particular preference where R³ is from 8 to 13 carbon atoms, where particular preference is given to R³ being from 11 to 13 carbon atoms; an example of these materials is lauric acid or myristic acid; or hydrogen (R³) and at least one carboxylic acid group (COOH). Materials explicitly excluded from the definition of the organic acids are organic arylsulfonic acids, such as sulfophthalic acid, and also naphthalenedisulfonic acids.

Marked preference is therefore given to those acids having long-chain, hydrophobic hydrocarbon moieties. These acids can also function as dispersing agents and/or processing aids.

A general requirement placed upon the silicon-containing precursor compound is that it is hydrolyzable under the conditions of the monosil and/or sioplas process, and thus liberates the free organic acid. It is preferable that the onset of the hydrolysis does not precede the crosslinking step of the processes, and that in particular it occurs after the shaping process, for example with introduction into the waterbath, or after the shaping process in the presence of moisture. Compounds excluded from the silicon-free precursor compounds are advantageously those which when hydrolyzed give an inorganic and an organic acid. An inorganic acid here does not include a silanol.

The silicon-containing precursor compound of an organic acid can have been applied to a carrier material, or encapsulated and/or embedded into a carrier material. According to another embodiment, if the silicon-containing precursor compound of an organic acid, in particular of the formula I and/or II, is used as silane hydrolysis catalyst and/or as silanol condensation catalyst and/or for grafting onto a polymer, or for copolymerization, or as adhesion promoter, it can be present in a composition or a masterbatch if appropriate with an organofunctional silane compound, if appropriate with a free-radical generator, and if appropriate with another silanol condensation catalyst.

In one preferred use, at least one silicon-containing precursor compound, in particular of an organic acid of the general formula I and/or II, is used as catalyst together with an organofunctional silane compound which corresponds to an unsaturated or olefinic alkoxysilane, where the silane compound particularly preferably corresponds to a monounsaturated alkoxysilane.

The invention uses the silicon-containing precursor compound as catalyst in a monosil process, in a sioplas process, and/or in a copolymerization process. It is particularly appropriate that the silane hydrolysis catalyst and/or silanol condensation catalyst does not become active until additional moisture is added. The final crosslinking of the unfilled or filled polymer therefore generally takes place in a known manner in a waterbath, in a steam bath, or else via atmospheric moisture, at ambient temperatures (the process known as “ambient curing”).

For the purposes of the present invention, the organofunctional silane compound is particularly suitable for grafting on a polymer and/or for copolymerization with a monomer, prepolymer, or parent polymer, and subsequent moisture-crosslinking.

Preferred organofunctional silane compounds are unsaturated alkoxysilanes, particularly preferably of the general formula III, an example being vinylalkoxysilane

(B)_{b}SiR⁴ₐ(OR⁵)_{3-b-a} (III)
where, mutually independently, b is 0, 1, 2, or 3, and a is 0, 1, 2, or 3, with the proviso that in formula III a+b is smaller than or equal to 3,
where B, mutually independently, is a monovalent (R⁷)₂C═C(R⁷)-E_{q}- group in formula III, in which R⁷ are identical or different, and R⁷ is a hydrogen atom or a methyl group or a phenyl group, the group E is a group from —CH₂—, —(CH₂)₂—, —(CH₂)₃—, —O(O)C(CH₂)₃—, or —C(O)O—(CH₂)₃—, q is 0 or 1, examples being vinyl, allyl, n-3-pentyl, n-4-butenyl, 3-methacryloxy-propyl, and/or acryloxypropyl, or isoprenyl, hexenyl, cyclohexenyl, terpenyl, squalanyl, squalenyl, polyterpenyl, betulaprenoxy, cis/trans-polyisoprenyl, or B encompasses an olefin group, for example R⁶-Dₚ-[C (R⁶)═C(R⁶)—C(R⁶)═C(R⁶)]ₜ-Dₚ- , in which R⁶ are identical or different, and R⁶ is a hydrogen atom or an alkyl group having from 1 to 3 carbon atoms, or an aryl group, or an aralkyl group, preferably a methyl group or a phenyl group, the groups D are identical or different, and D is a group from —CH₂—, —(CH₂)₂—, —(CH₂)₃—, —O(O)C(CH₂)₃—, or —C(O)O—(CH₂)₃—, and p is 0 or 1, and t is 1 or 2,
R⁵ is, mutually independently, methyl, ethyl, n-propyl, or isopropyl,
R⁴ is, mutually independently, a substituted or unsubstituted hydrocarbon group, in particular a substituted or unsubstituted linear, branched, and/or cyclic alkyl, alkenyl, alkylaryl, alkenylaryl, and/or aryl group having from 1 to 24 carbon atoms, in particular having from 1 to 16 carbon atoms, preferably having from 1 to 8 carbon atoms. In particular, the substituted groups are hydrophobic.
A particularly suitable alkyl group is an ethyl, n-propyl, isopropyl, n-butyl, isobutyl, cyclohexyl, n-octyl, isooctyl, or hexadecyl group, and a particularly suitable substituted alkyl group is a haloalkyl group having chlorine substituents or bromine substituents, preference being given to haloalkyl groups suitable for nucleophilic substitution, examples being 3-chloropropyl groups or 3-bromopropyl groups.

In particular if the composition has no components of group b), it is particularly preferable that B encompasses at least one olefin group, an example being polyethylene, polypropylene, propylene copolymer, or ethylene copolymer, if appropriate together with a free-radical generator and with other stabilizers and/or additives.

It is very particularly preferable that the organo-functional silane compounds of the general formula III used comprise vinyltrimethoxysilane, vinyltriethoxysilane, vinylmethyldialkoxysilane, vinyltriethoxymethoxysilane (VTMOEO), vinyltriisopropoxysilane, vinyltri-n-butoxysilane, 3-methacryloxypropyltriethoxysilane, 3-methacryloxypropyltrimethoxysilane (MEMO), and/or vinylethoxydimethoxysilane, and/or allylalkoxysilanes, such as allyltriethoxysilane. As an alternative, or in a mixture with the abovementioned compounds, the organofunctional silane compounds used can also comprise unsaturated siloxanes, preferred examples being oligomeric vinylsiloxanes, or a mixture of the abovementioned compounds. Preferred organofunctional silane compounds contain either a vinyl group or methacrylic group, since these compounds are reactive toward free radicals and are suitable for grafting onto a polymer chain or for copolymerization with monomers or with prepolymers.

The invention uses the at least one silicon-containing precursor compound, in particular of the formula I and/or II, if appropriate together with a free-radical generator and/or with an organofunctional silane compound, in a monosil process, or sioplas process, and/or in a copolymerization process, in particular together with thermoplastic parent polymers in a monosil or sioplas process, or in a copolymerization process, together with monomers and/or prepolymers of thermoplastic parent polymers.

In particular, the precursor compound is used in the abovementioned processes prior to the crosslinking reaction in essence under anhydrous conditions, in order to suppress any undesired hydrolysis and/or condensation prior to the actual use in the monosil process or sioplas process, or copolymerization process. The hydrolysis of the precursor compound preferably takes place after the shaping process, in particular with supply of heat, in the presence of moisture, preferably of added moisture.

The silicon-containing precursor compound can preferably also be used together with other silanol condensation catalysts, encompassing dibutyltin dilaurate, dioctyltin dilaurate; dioctyltin di(2-ethylhexanoate) ((C8H17)2Sn(OOCC7H15)2), dioctyltin di(isooctylmercaptoacetate) ((C8H17)2Sn—(SCH2CO2C8H17)2), dibutyltin dicarboxylate ((C4H9)2Sn(OOC—R)2), monobutyltin tris(2-ethylhexanoate) ((C4H9)Sn(OOCC7H15)3), dibutyltin dineodecanoate ((C4H9)2Sn(OOCC9H19)2), laurylstannoxane ([(C4H9)2Sn(OOCC11H23)]2O), dibutyltin diketonoate ((C4H9)2Sn(C5H7O2)2), dioctyltin oxide (DOTO) ((C8H17)2SnO), dibutyltin diacetate (DBTA) ((C4H9)2Sn(OOCCH3)2), dibutyltin maleate ((C4H9)2Sn(C4H2O4)2), dibutyltin dichloride ((C4H9)2SnCl2), dibutyltin sulfide ((C4H9)2SnS), dibutyltin oxide (DBTO) ((C4H9)2SnO), organotin oxides, monobutyltin dihydroxychloride ((C4H9)Sn(OH)2Cl), monobutyltin oxides (MBTO) ((C4H9)SnOOH), dibutyltin bis(isooctyl maleate), ((C4H9)2Sn(Cl2H19O4)2). The concentration of the conventional catalysts, such as the tin-containing catalyst, can thus be markedly reduced in comparison with sole use.

Thermoplastic parent polymers for the purposes of the invention are in particular acrylonitrile-butadiene-styrene (ABS), polyamides (PA), polymethyl methacrylate (PMMA), polycarbonate (PC), polyethylene (PE), polypropylene (PP), polystyrene (PS), polyvinyl chloride (PVC), and also ethylene-vinyl acetate copolymers (EVA), EPDM, or EPM, which are polymers based on ethylene units, and/or celluloid, or silane-copolymerized polymers, and monomers and/or prepolymers are precursor compounds of said parent polymers, examples being ethylene and propylene. Other thermoplastic parent polymers are mentioned below.

Preferred thermoplastic parent polymers are a silane-grafted parent polymer, a silane-copolymerized parent polymer, and/or monomers and/or prepolymers of said parent polymers, or else silane block coprepolymers or block coprepolymers, and/or a mixture of these. It is preferable that the thermoplastic parent polymer is a nonpolar polyolefin, an example being polyethylene or polypropylene, or a polyvinyl chloride, or a silane-grafted polyolefin and/or silane-copolymerized polyolefin, and/or a copolymer of one or more olefins and of one or more comonomers which contain polar groups.

The thermoplastic parent polymer can also function to some extent or completely as carrier material, for example in a masterbatch, encompassing, as carrier material, a thermoplastic parent polymer or a polymer and the silicon-containing precursor compound of an organic acid and, if appropriate, an organofunctional silane compound, and/or a free-radical generator.

Other examples of silane-copolymerized thermoplastic parent polymers are ethylene-silane copolymers, for example ethylene-vinyltrimethoxysilane copolymer, ethylene-vinyltriethoxysilane copolymer, ethylene-dimethoxyethoxysilane copolymer, ethylene-gamma-trimethoxysilane copolymer, ethylene-gamma-(meth)acryl-oxypropyltriethoxysilane copolymer, ethylene-gamma-acryloxypropyltriethoxysilane copolymer, ethylene-gamma-(meth)acryloxypropyltrimethoxysilane copolymer, ethylene-gamma-acryloxypropyltrimethoxysilane copolymer, and/or ethylene-triacetoxysilane copolymer.

The nonpolar thermoplastic parent polymers used can comprise thermoplastics such as in particular an unmodified PE grade, an example being LDPE, LLDPE, HDPE, or mPE. Parent polymers bearing polar groups give by way of example improved fire performance, i.e. lower flammability and smoke density, and increase capability to accept filler. Examples of polar groups are hydroxy, nitrile, carbonyl, carboxy, acyl, acyloxy, and carboalkoxy groups, and amino groups, and also halogen atoms, in particular chlorine atoms. Olefinic double bonds and carbon-carbon triple bonds are nonpolar. Suitable polymers are not only polyvinyl chloride but also copolymers of one or more olefins and of one or more comonomers which contain polar groups, e.g. vinyl acetate, vinyl propionate, (meth)acrylic acid, methyl(meth)acrylate, ethyl(meth)acrylate, butyl(meth)acrylate, or acrylonitrile. Examples of the amounts of the polar groups in the copolymers are from 0.1 to 50 mol %, preferably from 5 to 30 mol %, based on the polyolefin units. Particularly suitable parent polymers are ethylene-vinyl acetate copolymers (EVA). By way of example, a suitable commercially available copolymer contains 19 mol % of vinyl acetate units and 81 mol % of ethylene units.

Particularly suitable parent polymers are polyethylene, polypropylene, and also corresponding silane-modified polymers. In particular, therefore, the use of silicon-containing precursor compounds of an organic acid in a composition or a masterbatch can give silane-grafted, silane-copolymerized, and/or silane-crosslinked PE, PP, polyolefin copolymer, EVA, EPDM, or EPM in an advantageous manner. The silane-grafted polymers can be in a form filled with fillers or in an unfilled form and, if appropriate, can be moisture-crosslinked subsequently, after a shaping process. A corresponding situation applies to the silane-copolymerized polymers in a form filled with fillers or in unfilled form, and these polymers can, if appropriate, be moisture-crosslinked subsequently, after a shaping process.

The invention also provides the use of a silicon-containing precursor compound of an organic acid, in particular of the formula I and/or II, in the production of unfilled Si-crosslinked compounded polymer materials and/or in the production of filled Si-crosslinked compounded polymer materials; and/or of corresponding filled Si-crosslinked or unfilled Si-crosslinked polymers based on thermoplastic parent polymers. Si-Crosslinking means the formation of an Si—O-substrate bond or Si—O—Si bond, for example between silanols, an example being the hydrolyzed organofunctionalized silane (III), or between silicates, or between silicas, or between derivatives. The substrate used can be any of the functionalized substrates capable of participation in the condensation process, and in particular can be the abovementioned fillers, carrier materials, pigments, or products of hydrolysis of, and/or condensation of, the organofunctional silanes, etc.

The invention further provides the use of at least one silicon-containing precursor compound of an organic acid in the production of products, in particular moldings, preferably of cables, hoses, or pipes, particularly preferably of drinking-water pipes, or else of hoses in the medical-technology sector.

The substitution pattern of the silicon-containing precursor compound of an organic acid can cause it to be in liquid or waxy to solid form; it is preferably waxy to solid, or encapsulated or embedded, or bound to a carrier material. This measure can make it easy to store the precursor compound in anhydrous form, and to meter the precursor compound. Undesired hydrolysis and/or condensation prior to use, in particular in a monosil process, sioplas process, or copolymerization process, can be suppressed.

In order to permit better regulation of metering capability and, if appropriate, susceptibility to hydrolysis, the silicon-containing precursor compound of an organic acid of the general formula I and/or II, the organofunctional silane compound and, if appropriate, the free-radical generator can have been applied to a carrier material, for example as described in EP 0 426 073.

To the extent that the silicon-containing precursor compound I and/or II is itself solid, it can itself be used as carrier material, in particular for an organofunctional silane, for example as a carrier material for a silane of the general formula III, for example of vinyltriethoxysilane, vinyltrimethoxysilane, vinyltris(methoxyethoxy)silane, vinyl (co)oligomers, or other liquid silanes of the formula III.

In one embodiment, the at least one silicon-containing precursor compound of an organic acid can have been applied to a carrier material, or encapsulated and/or embedded into a carrier material. For better metering capability, it is preferable to provide the silicon-containing precursor compound of an organic acid in solid or flowable form, or else by way of example in a composition or a masterbatch, if appropriate, with an organofunctional silane compound and/or, if appropriate, a free-radical generator, and also in particular with at least one further silane hydrolysis catalyst and/or silanol condensation catalyst, in the form of solid, flowable formulation, for example on and/or in a carrier material and/or filler as carrier.

The carrier can be porous, particulate, swellable or, if appropriate, take the form of a foam. Suitable carrier materials are in particular polyolefins, such as PE, PP, EVA, or polymer blends, and suitable fillers are in particular inorganic or mineral fillers which can advantageously have reinforcing, extending, or else flame-retardant effect. The carrier materials and fillers are specified in more detail below.

Preferred free-radical generators are organic peroxides and/or organic peresters, or a mixture of these, preferred examples being tert-butyl peroxypivalate, tert-butyl 2-ethylperoxyhexanoate, dicumyl peroxide, di-tert-butyl peroxide, tert-butyl cumyl peroxide, 1,3-di(2-tert-butylperoxyisopropyl)benzene, 2,5-dimethyl-2,5-bis(tert-butylperoxy)hex-3-yne, di-tert-amyl peroxide, 1,3,5-tris(2-tert-butylperoxy-isopropyl)benzene, 1-phenyl-1-tert-butylperoxyphthalide, alpha,alpha′-bis(tert-butylperoxy)diisopropylbenzene, 2,5-dimethyl-2,5-di-tert-butylperoxyhexane, 1,1-di(tert-butylperoxy)-3,3,5-trimethylcyclohexane (TMCH). It can also be advantageous to use n-butyl 4,4-di(tert-butylperoxy)valerate, ethyl 3,3-di(tert-butylperoxy)butyrate, and/or 3,3,6,9,9-hexamethyl-1,2,4,5-tetraoxacyclononane.

The use can also take place in a composition or a masterbatch together with at least one stabilizer and/or other additional substance, and/or additive, or a mixture of these. The stabilizer and/or other additional substances used can, if appropriate, comprise metal deactivators, processing aids, inorganic or organic pigments, fillers, carrier materials, and adhesion promoters. Examples of these are titanium dioxide (TiO₂), talc, clay, quartz, kaolin, aluminum hydroxide, magnesium hydroxide, bentonite, montmorillonite, mica (muscovite mica), calcium carbonate (chalk, dolomite), dyes, pigments, talc, carbon black, SiO₂, precipitated silica, fumed silica, aluminum oxides, such as alpha- and/or gamma-aluminum oxide, aluminum oxide hydroxides, boehmite, baryte, barium sulfate, lime, silicates, aluminates, aluminum silicates, and/or ZnO, or a mixture of these. It is preferable that the carrier materials or additional substances, such as pigments or fillers, are pulverulent, particulate, porous, or swellable or, if appropriate, take the form of a foam.

Examples of preferred metal deactivators are N,N′-bis(3-(3,5-di-tert-butyl-4-hydroxyphenyl)propionyl)hydrazine, and also tris(2-tert-butyl-4-thio(2′-methyl-4-hydroxy-5′-tert-butyl)phenyl-5-methyl)phenyl phosphite.

The use can also in particular take place in a composition or a masterbatch together with further components such as at least one heat stabilizer, an example being pentaerythritol tetrakis[3-(3,5-bis(1,1-dimethylethyl)-4-hydroxyphenyl)propionate], octadecyl 3-(3,5-di-tert-butyl-4-hydroxyphenyl)propionate, or else 4,4′-bis(1,1-dimethylbenzyl)diphenylamine.

The fillers used are generally inorganic or mineral fillers and can advantageously have reinforcing, extending, or else flame-retardant effect. At least at their surfaces, they bear groups which can react with the alkoxy groups or the hydroxy groups of the silanols, or the unsaturated silane compound, or the hydrolyzed compound of the formula I and/or II. The result of this can be that the silicon atom, with the functional group bonded thereto, becomes chemically fixed on the surface. Particular examples of groups of this type on the surface of the filler are hydroxy groups. Fillers used with preference are accordingly metal hydroxides having a stoichiometric proportion of hydroxy groups or, in the various dehydrated forms thereof, having a substoichiometric proportion of hydroxy groups, extending as far as oxides having comparatively few residual hydroxy groups, where these are however detectable by DRIFT-IR spectroscopy or NIR spectroscopy.

Fillers used with particular preference are aluminum trihydroxide (ATH), aluminum oxide hydroxide (AlOOH.aq), magnesium dihydroxide (MDH), brucite, huntite, hydromagnesite, mica, and montmorillonite. Other fillers that can be used are calcium carbonate, talc, and also glass fibers. It is also possible to use the materials known as “char formers”, examples being ammonium polyphosphate, stannates, borates, talc, or materials of these types in combination with other fillers.

Preferable suitable carrier material is a porous polymer selected from polypropylene, polyolefins, ethylene copolymer using low-carbon alkenes, ethylene-vinyl acetate copolymer, high-density polyethylene, low-density polyethylene, or linear low-density polyethylene, where the porous polymer can have a pore volume of from 30 to 90% and in particular can be used in the form of granules or pellets.

As an alternative, the carrier material can also be a filler or additional substance, in particular a nanoscale filler. Preferred carrier materials, fillers, or additional substances are aluminum hydroxide, magnesium hydroxide, fumed silica, precipitated silica, wollastonite, calcined variants, chemically and/or physically modified materials, such as kaolin, modified kaolin, and in particular ground, exfoliating materials, such as phyllosilicates, preferably specific kaolins, a calcium silicate, a wax, such as a polyolefin wax based on LDPE (low-density polyethylene), or a carbon black.

The carrier material can encapsulate the silicon-containing precursor compound and/or the organofunctional silane compound, and/or the free-radical generator, or can retain these in physically or chemically bound form, in particular in the form of masterbatch. It is advantageous here if the loaded or unloaded carrier material is swellable, in particular in a solvent. The amount of the silicon-containing precursor compounds is usually in the range from 0.01% by weight to 99.9% by weight, preferably from 0.01% by weight to 70% by weight, particularly preferably from 0.1% by weight to 50% by weight, with particular preference from 0.1% by weight to 30% by weight, based on the total weight encompassing the carrier material, the organofunctional silane compound, and/or the free-radical generator. The amount present of the carrier material is therefore generally from 99.99 to 70% by weight, based on the total weight (giving 100% by weight).

Individual preferred carrier materials that may be mentioned are: ATH (aluminum trihydroxide, Al(OH)₃), magnesium hydroxide (Mg(OH)₂), or fumed silica, which is produced on an industrial scale via continuous hydrolysis of silicon tetrachloride in a hydrogen/oxygen flame. This process vaporizes the silicon tetrachloride which then reacts spontaneously and quantitatively within the flame with the water derived from the hydrogen/oxygen reaction. Fumed silica is an amorphous form of silicon dioxide and is a free-flowing, bluish powder. Particle size is usually in the region of a few nanometers, and specific surface area is therefore large, generally being from 50 to 600 m²/g. The process by which the vinylalkoxysilanes and/or the silicon-containing precursor compound, or a mixture of these, becomes attached to the material here is therefore in essence adsorption.

Precipitated silicas are generally produced from sodium waterglass solutions, via neutralization with inorganic acids under controlled conditions. After isolation from the liquid phase, washing, and drying, the crude product is finely ground, e.g. in steam-jet mills. Again, precipitated silica is a substantially amorphous silicon dioxide, the specific surface area of which is generally from 50 to 150 m²/g. Unlike fumed silica, precipitated silica has a certain porosity, for example about 10% by volume. The process by which the vinylalkoxysilanes and/or the silicon-containing precursor compound, or a mixture of these, becomes attached to the material can therefore be either adsorption on the surface or absorption within the pores. Calcium silicate is generally produced industrially by fusing quartz or kieselguhr with calcium carbonate or calcium oxide, or via precipitation of aqueous sodium metasilicate solutions with water-soluble calcium compounds. The carefully dried product is generally porous and can absorb up to five times the amount by weight of water or oils.

Porous polyolefins, such as polyethylene (PE) or polypropylene (PP), and also copolymers, such as ethylene copolymers with low-carbon alkenes, such as propene, butene, hexene, or octene, or ethylene-vinyl acetate (EVA) are produced via specific polymerization techniques and polymerization processes. Particle sizes are generally from 3 to <1 mm, and porosity can be above 50% by volume, and the products can therefore absorb suitably large amounts of unsaturated organosilane/mixtures, for example of the general formula III, and/or of the silicon-containing precursor compound, or a mixture of these, without losing their free-flow properties.

Particularly suitable waxes are polyolefin waxes based on low-density polyethylene (LDPE), preferably branched, with long side chains. The melting and freezing point is generally from 90 to 120° C. The waxes generally give good results in mixing with the unsaturated organosilanes, such as vinylalkoxysilane, and/or with the silicon-containing precursor compound, or a mixture of these, in a low-viscosity melt. The solidified mixture is generally sufficiently hard to be capable of granulation.

The various commercially available forms of carbon black are suitable by way of example for producing black cable sheathing.

The following methods inter alia are available for producing the compositions (dry liquids) on carriers, examples being compositions made of olefinic silane carboxylates, such as vinylsilane carboxylate of myristic acid or lauric acid, and carrier material, or else of vinylsilane stearate and carrier material, or of a tetracarboxysilane and vinylalkoxysilane with carrier material:

Among the best-known methods is spray drying. Alternative methods are explained in more detail below: mineral carriers or porous polymers are generally preheated, e.g. to 60° C. in an oven, and charged to a cylindrical container which has been flushed with, and filled with, dry nitrogen. A vinylalkoxysilane and/or vinylcarboxysilane is generally then added, and the container is placed in a roller apparatus which rotates it for about 30 minutes. After this time, the carrier substance and the liquid, high-viscosity or waxy alkoxysilane and/or carboxysilane have usually formed flowable, dry-surface granules which are advantageously stored under nitrogen in containers impermeable to light. As an alternative, the heated carrier substance can be charged to a mixer flushed and filled with dry nitrogen, e.g. a plowshare mixer of LÖDIGE type or a propeller mixer of HENSCHEL type. The mixer element can then be operated and the olefinic alkoxysilane and/or carboxysilane, in particular of the formula I, or a mixture of these, can be sprayed in by way of a nozzle once the maximum mixing rate has been reached. When addition has been completed, homogenization generally continues for a further approximately 30 minutes, and the product is then discharged into nitrogen-filled containers impermeable to light, for example by means of a pneumatic conveying system operated with dry nitrogen.

Polyethylene wax or any other wax in pelletized form with a melting point of from 90 to 120° C. or above can be melted in portions in a heatable vessel with stirrer, reflux condenser, and liquid-addition apparatus, and maintained in the molten state. Dry nitrogen is suitably passed through the apparatus during the entire production process. By way of the liquid-addition apparatus it is possible by way of example to add the liquid vinylcarboxysilane/mixtures progressively to the melt and mix these with the wax by vigorous stirring. The melt is then generally discharged into molds to solidify, and the solidified product is granulated. As an alternative, the melt can be allowed to drip onto a cooled molding belt on which it solidifies in the form of user-friendly pastilles.

In one preferred embodiment, the composition used is composed of a selection of a silicon-containing precursor compound of an organic acid, in particular of the formula I and/or II, and, if appropriate, of a monounsaturated alkoxysilane and/or of another silanol condensation catalyst, an example being one of the abovementioned tin compounds, and/or of a free-radical generator and also, if appropriate, of at least one stabilizer and/or additional substance, and/or carrier material, and/or additive, and/or a mixture of these.

In another preferred embodiment, the composition used is composed of a selection of a precursor compound of the formula I and/or II, where R¹ corresponds to a carbonyl-R³ group where R³ is from 4 to 45 carbon atoms, preferably having from 6 to 45 carbon atoms, in particular having from 6 to 22 carbon atoms, preferably having from 8 to 22 carbon atoms, particularly preferably having from 6 to 14 carbon atoms, with particular preference where R³ is from 8 to 13 carbon atoms, in particular where R³ is from 11 to 13 carbon atoms, and, if appropriate, of an olefinic alkoxysilane, in particular of the formula III, and/or of a free-radical generator, and/or of a further silanol condensation catalyst, and also, if appropriate, of at least one stabilizer and/or additional substance, and/or carrier material, and/or additive, and/or a mixture of these.

The invention also provides a masterbatch, in particular for the crosslinking of thermoplastic parent polymers, encompassing at least one silicon-containing precursor compound of an organic acid and encompassing at least one free-radical generator.

An alternative embodiment of the invention provides a masterbatch, in particular for the crosslinking of thermoplastic parent polymers, encompassing, as component A, at least one silicon-containing precursor compound of an organic acid, in particular of the general formula I and/or II, corresponding to the definition above, and also one carrier material, and, if appropriate, as component B, one free-radical generator, and, if appropriate, as component C, one organofunctional silane compound, in particular one unsaturated alkoxysilane, preferably of the formula III, where the definitions of b, a, B, R⁴, and R⁵ are as above, where at least one of the above components A, B, and/or C is on a carrier or has been encapsulated. It is preferable that at least one of the components has been applied to at least one carrier or one carrier material, or has been embedded, or has been encapsulated by a carrier material. The masterbatch, or one of components A, B, and/or C, can moreover encompass at least one additional substance, stabilizer, additive, or a mixture of these.

In one embodiment, the organofunctional silane compound is on a carrier and/or has been encapsulated in the silicon-containing precursor compound.

It is preferable that component A comprises from 0.01 to 99.9% by weight, in particular from 0.01 to 70% by weight, preferably from 0.1 to 50% by weight, particularly preferably from 0.1 to 30% by weight, of at least one silicon-containing precursor compound of an organic acid, in particular of the general formula I and/or II as defined above, and a carrier material making up the balance of 100% by weight, or in alternatives, also at least one stabilizer, one additional substance, one additive, or one mixture of these making up the balance of 100% by weight of component A.

The usual amount of the free-radical generator of component B is from 0.05 to 10% by weight in component B, where there is at least one additional substance, carrier material, stabilizer, additive, or a mixture of these making up the balance of 100% by weight of component B.

The usual amount of the organofunctional silane compound, in particular of the formula III, of component C is from 60 to 99.9% by weight in component C, where there is at least one additional substance, carrier material, stabilizer, additive, or a mixture of these making up the balance of 100% by weight of component C.

Suitable free-radical generators, additional substances, stabilizers, additives, and also carrier materials have been described above. Particular carrier materials that can be used are those mentioned above, examples being PE, PP, and also others mentioned above. Similar considerations apply to the free-radical generator and to the stabilizer. Components A and B, or A and C, are preferably present separately from one another within the masterbatch where the intention is to use them in two steps of the process. In the case of simultaneous use, components A, B, and/or C can be present together in a physical mixture, for example in the form of powder, granules, or pellets, or else can be present in a single formulation, for example in pellet form or tablet form.

One preferred masterbatch comprises by way of example 6% by weight of a silicon-containing precursor compound of an organic acid, for example of a fatty acid, in particular myristic acid, or lauric acid, on a polymeric carrier material, such as HDPE, where the amount of HDPE present is 94% by weight of the masterbatch (component A), making up the balance of 100% by weight. Other masterbatches encompass silicon-containing precursor compounds of an organic acid based on behenic acid, L-leucine, capric acid, oleic acid, lauric acid, and/or myristic acid, if appropriate in a mixture on a carrier material, for example HDPE.

The component C present can preferably comprise an unsaturated alkoxysilane, in particular of the formula III, or oligomeric siloxanes produced therefrom, preferably vinyltrimethoxysilane or vinyltriethoxysilane, together with a free-radical generator and with a stabilizer, if appropriate with further additives. Preferably on a carrier material, for example in the form of granules.

The invention uses the silicon-containing precursor compounds of an organic acid, by way of example, in a composition or a masterbatch, as silane hydrolysis catalyst and/or silanol condensation catalyst, in a monosil process, in a sioplas process, or in a copolymerization process, in particular for the production of filled and/or unfilled compounded polymer materials, which may be in crosslinked or uncrosslinked form, and/or of crosslinked filled and/or unfilled polymers based on thermoplastic parent polymers. For the purposes of the invention, crosslinking in particular means the formation of an Si—O-substrate bond or Si—O-filler or Si—O-carrier material, or Si—O—Si bridging, i.e. the condensation of an Si—OH group with a condensable other group of a substrate.

The invention also provides the use of a silicon-containing precursor compound of an organic acid, in particular of the formula I and/or II, in the production of a silicon-containing polymer, or compounded polymer material, or of an unfilled crosslinked polymer, and/or of a filled crosslinked polymer. The use preferably takes place in a monosil process, in a sioplas process, and/or in a copolymerization process. The silicon-containing precursor compound I and/or II here can also be used for the purposes of the present invention, for grafting onto a polymer and/or for copolymerization with a monomer, prepolymer, or parent polymer, and subsequent moisture-crosslinking.

Preference is given to the use for the production of silane-grafted, silane-copolymerized, and/or crosslinked, in particular siloxane-crosslinked, filled or unfilled polymers. The abovementioned polymers can also encompass block copolymers. It is preferable that the fillers are likewise crosslinked with the silicon-containing compounds, in particular by way of an Si—O-filler/carrier material bond. Particular fillers that can be used are the abovementioned fillers or carrier materials.

The invention also provides the use of the silicon-containing precursor compound in the production of a polymer, or compounded polymer material, such as an unfilled crosslinked polymer and/or a filled crosslinked polymer, compounded cable material, a filled plastic, or molding, and/or product. Appropriate moldings and/or products are cables, hoses, and pipes, such as drinking-water pipes, or products which can be used in the food-and-drink sector or in the sector of hygiene products, or in the sector of medical technology, for example in the form of a medical instrument or part of a medical instrument, Braunüle, trocar, stent, clot retriever, vascular prosthesis, or component of a catheter, to mention just a few possibilities.

The moisture-crosslinked unfilled or filled compounded polymer materials of the invention are generally produced via appropriate mixing of the respective starting-material components in the melt, advantageously with exclusion of moisture. The usual heatable homogenization apparatuses are generally suitable for this purpose, examples being kneaders or advantageously for continuous operation Buss cokneaders or twin-screw extruders. As an alternative to these, it is also possible to use a single-screw extruder. A possible method here introduces the components continuously, in each case individually or in partial mixtures, in the prescribed quantitative proportion, to the extruder, which has been heated to a temperature above the melting point of the thermoplastic parent polymer. It is advantageous that the temperature rises in the direction toward the end of the screw, in order to establish a low viscosity and thus permit intensive mixing. In an advantageous method, the extrudates are still liquid when they are introduced to an apparatus for the molding of granules or of moldings, such as pipes or hoses. The final crosslinking of the unfilled or filled polymer generally takes place in a known manner in a waterbath, in a steam bath, or else via atmospheric moisture at ambient temperatures (the process known as “ambient curing”).

The invention also provides a product comprising a silicon-containing precursor compound of an organic acid, in particular of the formula I and/or III, and/or products of the hydrolysis and/or condensation thereof, in particular a molding made of a polymer, such as a crosslinked filled or crosslinked unfilled polymer; preferably a flame-retardant or other cable, for example filled with Mg(OH)₂ or Al(OH)₃, or with exfoliating materials, such as phyllosilicates; or a pipe, for example a drinking-water pipe, or a hose in the medical sector, or products which can be used in the food-and-drinks sector or in the sector of hygiene products, or in the sector of medical technology, for example as medical instrument or part of a medical instrument, hose, Braunüle, trocar, stent, clot retriever, vascular prosthesis, or component of a catheter, to mention just a few possibilities.

In the case of single-stage processes, for example in the case of the monosil process, the polymer and the composition that initiates crosslinking, or the masterbatch, are charged to the extruder, and the resultant melt is processed in one step to give the final product. The composition used can appropriately be a composition which encompasses an organofunctional silane compound, in particular of the formula III, and which encompasses a free-radical generator, and which also encompasses a silicon-containing precursor compound of an organic acid and, if appropriate, encompasses another silanol condensation catalyst, and also, if appropriate, encompasses a stabilizer.

For the production of filled plastics, the inorganic filler is mostly introduced directly to the compounding assembly and processed with the polymer to give the final product. The filler can also optionally be introduced at a later juncture into the assembly, for example in the case of a twin-screw extruder or cokneader. The graft polymer produced using the silicon-containing precursor compound of an organic acid can give markedly better compatibility of nonpolar polymer and polar filler, for example aluminum hydroxide or magnesium hydroxide.

It is also possible to produce a graft polymer, in particular sioplas material, separately and, if appropriate, to granulate and package the material, in particular with protection from moisture, and to store the same and then to supply the same as feedstock to a processor, for example a cable producer or pipe producer, who in turn incorporates fillers to produce final filled plastics products.

The following examples provide further illustration of the inventive use and the masterbatch, but the invention is not restricted to these examples.

A) Production of alkyl- or alkenyltricarboxysilane, or tetracarboxysilane

### GENERAL EXAMPLES

a) For the production of alkenyltricarboxysilane, 1 mol of an alkenyltrichlorosilane, or in general terms an alkenyltrihalosilane, is reacted directly with 3 mol, or with an excess, of the organic monocarboxylic acid, or reacted in an inert solvent, in particular at elevated temperature.
b) For the production of an alkyltricarboxysilane, 1 mol of an alkyltrichlorosilane is correspondingly reacted directly with 3 mol, or with an excess, of an organic monocarboxylic acid, or is reacted in an inert solvent. It is preferable that the reaction takes place at elevated temperature, for example at up to the boiling point of the solvent, or at around the melting point of the organic fatty acid or of the organic acid.
c) For the production of tetracarboxysilanes, 1 mol of tetrahalosilane, in particular tetrachlorosilane or tetrabromosilane, is reacted with 4 mol, or with an excess, of at least one monocarboxylic acid, for example one fatty acid or fatty acid mixture. The reaction can take place directly via melting or in an inert solvent, preferably at elevated temperature.

### Example 1

### Production of vinyltristearylsilane

Reaction of 1 mol of vinyltrichlorosilane with 3 mol of stearic acid in toluene as solvent: 50 g of stearic acid (50.1 g) were used as initial charge with 150.0 g of toluene in a flask. The solid dissolves after gentle heating. Cooling gives a cloudy, highly viscous mass, which when reheated again forms a clear liquid. The oil bath was set to 95° C. at the start of the experiment, and about 20 minutes of mixing time gave a clear liquid. 9.01 g of vinyltrichlorosilane were then rapidly added dropwise with a pipette. After about 10 min the mixture was a clear liquid, and the oil temperature was adjusted to 150° C. After about a further 3 h after the start of the experiment, the mixture was cooled under inert gas. It was worked up by distillative removal of the toluene. This gave a white solid which when melted had an oily and yellowish appearance. For further purification, the solid can be subjected to further rotary evaporator treatment, for example for a prolonged period (3-5 h) at an oil bath temperature of about 90° C. and at a vacuum <1 mbar. The solid was characterized as vinyltrichlorosilane by way of NMR (¹H, ¹³C, ²⁹Si).

### Example 2

### Production of vinyltridecanoic acid

Reaction of 1 mol of vinyltrichlorosilane with 3 mol of capric acid in toluene as solvent: 60.0 g of capric acid (decanoic acid) were used as initial charge with 143.6 g of toluene in a flask. The oil bath was set to 80° C. at the start of the experiment, and the vinyltrichlorosilane was slowly added dropwise (about 0.5 h for 19.1 g) while the temperature of the mixture was about 55° C. After about 45 min, the temperature of the oil was increased to 150° C. After a reaction time of about a further 2 h, the oil bath was switched off, but the stirring, the water-cooling, and the nitrogen blanketing were continued until cooling was complete. The clear liquid was transferred to a single-necked flask, and the toluene was drawn off in a rotary evaporator. The oil bath temperature was set to about 80° C. The vacuum was adjusted stepwise to <1 mbar. The product was a clear liquid. The liquid was characterized as vinyltricaprylsilane by way of NMR (¹H, ¹³C, ²⁹Si).

### Example 3

### Production of hexadecyltricaprylsilane

Reaction of 1 mol of Dynasylan® 9016 (hexadecyltrichlorosilane) with 3 mol of capric acid in toluene as solvent: 73.1 g of capric acid (decanoic acid) were used as initial charge with 156.2 g of toluene in a flask. The oil bath was set to 95° C. at the start of the experiment, and 50.8 g of Dynasylan® 9016 were added dropwise over a period of about 25 minutes. After about min, the temperature of the oil was increased to 150° C. The experiment was terminated after reflux for about 1.5 h. The toluene was drawn off from the clear liquid in a rotary evaporator. The oil bath temperature was set to about 80° C. The vacuum was adjusted stepwise to <1 mbar. The product was a yellow oily liquid with a slightly pungent odor. The liquid was characterized in essence as hexadecyltricaprylsilane by way of NMR (¹H, ¹³C, ²⁹Si).

### Example 4

### Production of vinyltripalmitylsilane

Reaction of 1 mol of vinyltrichlorosilane with 3 mol of palmitic acid in toluene as solvent: 102.5 g of palmitic acid were used as initial charge with 157.0 g of toluene in a flask. The oil bath was set to 92° C. at the start of the experiment, and the 22.0 g of vinyltrichlorosilane were slowly added dropwise over a period of about 15 minutes. After about 70 min, the temperature of the oil was increased to 150° C. The mixture was heated at reflux for about 4 h, and then the toluene was removed by distillation. The oil bath temperature was adjusted to about 80° C., and the vacuum was adjusted stepwise to 2 mbar. Cooling of the product gave a white, remeltable solid. The solid was characterized as vinyltripalmitylsilane by way of NMR (¹H, ¹³C, ²⁹Si).

### Example 5

### Production of chloropropyltripalmitylsilane

Reaction of 1 mol of CPTCS (chloropropyltrichlorosilane) with 3 mol of palmitic acid in toluene as solvent: 40.01 g of palmitic acid were used as initial charge in a three-necked flask, and the oil bath was heated. Once all of the palmitic acid had dissolved, 11.03 g of the CPTCS (99.89% purity (GC/TCD)) were added dropwise within a period of about 10 min. The temperature was finally increased to 130° C. After about 3.5 h no further gas activity was observed in an attached gas-washer bottle, and the synthesis was terminated. The toluene was removed in a rotary evaporator. At a subsequent juncture, the solid was remelted and stirred at an oil bath temperature of about 90° C. under a vacuum of <1 mbar. After about 4.5 h, no further gas bubbles were observed. The solid was characterized as chloropropyltripalmitylsilane by way of NMR (¹H, ¹³C, ²⁹Si).

### Example 6

### Production of propyltrimyristylsilane

Reaction of 1 mol of PTCS (propyltrichlorosilane, 98.8% purity) with 3 mol of myristic acid in toluene as solvent. The reaction was analogous to that in the above examples. The reaction product was characterized as propyltrimyristylsilane.

### Example 7

### Production of vinyltrimyristylsilane (VTC)

Reaction of Dynasylan® VTC with myristic acid: 40.5 g of myristic acid and 130 g of toluene are used as initial charge in the reaction flask, and mixed and heated to about 60° C. 9.5 g of Dynasylan® VTC are added dropwise within a period of 15 min by means of a dropping funnel. The temperature in the flask increases by about 10° C. during addition. After addition, stirring is continued for 15 minutes, and then the temperature of the oil bath is increased to 150° C. During the continued stirring, gas evolution (HCL gas) can be observed. Stirring was continued until no further gas evolution was observed (gas discharge valve), and stirring was continued for 3 h. After cooling of the mixture, unreacted Dynasylan® VTC and toluene were removed by distillation at about 80° C. at reduced pressure (0.5 mbar). The product remaining in the reaction flask is stored overnight in the flask with N₂ blanketing and then discharged without further work-up. The product subsequently solidifies. About 44.27 g of crude product were obtained.

### Example 8

### Production of propyltrimyristylsilane

Reaction of Dynasylan® PTCS with myristic acid: 40.5 g of myristic acid and 150 g of toluene are used as initial charge in the reaction flask, and mixed and heated to about 60° C. Dynasylan® PTCS is added dropwise within a period of 15 minutes by means of a dropping funnel. The temperature in the flask increases by about 10° C. during addition. After addition the temperature of the oil bath is increased to 150° C. and stirring is continued for 3 h. During the continued stirring, gas evolution, HCL gas, can be observed. Stirring was continued until no further gas evolution was observed at the gas discharge valve. After cooling of the mixture, unreacted Dynasylan® PTCS and toluene were removed by distillation at about 80° C. at reduced pressure (0.5 mbar). The product was stored under inert gas and solidified. About 44.0 g of crude product were obtained.

### B) Crosslinking Examples

Dynasylan® SILFIN 24 (vinyltrimethoxy (VTMO), peroxide, and processing aid)

### Example 9

Step A—Grafting of MG9641S HDPE from Borealis with Dynasylan® SILFIN 24 Mixtures

The grafting took place in a (ZE 25) twin-screw extruder from Berstorff. The experiments produced strands. The crosslinking agent preparation was in each case applied for 1 h to the PE in a mixing drum, after predrying at 70° C. for about 1 h. The grafted strands were granulated after extrusion. The granules were packaged directly after the granulation process in bags coated with an aluminum layer and these were closed by welding. Prior to the welding process, the granules were blanketed with nitrogen.

Processing parameters for the grafting reaction in the ZE 25

Temperature profile: −/150/160/200/200/210/210/210° C.

Rotation rate: about 100 rpm, addition: 1.5 phr of Dynasylan® SILFIN 24

Step B—Processing for the Crosslinking Study

The silane-grafted polyethylene was kneaded in a laboratory kneader (Thermo HAAKE, 70 cm³) with the respective catalyst (temperature profile: 140° C./3 min; 2 min up to 210° C.; 210° C./5 min, kneader rotation rate: 30 rpm). The mixture was then pressed at 200° C. to give sheets. Crosslinking took place in a waterbath at 80° C. (4 h). The gel contents of the crosslinked sheets were determined (8 h, p-xylene, Soxhlet extraction).

1) Screening with Fatty Acids, Precursor Compounds of the Fatty Acids, and Amino Acids

In each case 95% by weight of silane-grafted PE with 5% by weight of catalyst masterbatch, where the catalyst masterbatch comprised 98% by weight of HDPE and 2% by weight of catalyst (organic acid). The results can be found in table 1.

TABLE 1
Gel contents for the study with various catalysts

| | Gel [%] | |
|---|---|---|
| | 22 h at 80° C. | |
| Catalyst | Waterbath | Catalyst type |
| Without catalyst | 34 | — |
| Hexadecyltripalmitic | 49 | Silicon-containing |
| acid silane | | precursor compound |
| | | of a fatty acid |
| Tegokat 216 (DOTL) | 66 | Tin catalyst |

### Example 10

a) Grafting of MG9641S HDPE from Borealis with Dynasylan® SILFIN 24

The grafting took place in a ZE 25 extruder from Berstorff. The crosslinking agent preparation was in each case applied for 1 h to the PE in a mixing drum, after predrying at 70° C. for about 1 h. The grafted strands were granulated after extrusion. The granules were packaged directly after the granulation process in polyethylene-aluminum-polyethylene packaging and these were closed by welding. Prior to the welding process, the granules were blanketed with nitrogen.

Processing parameters for the grafting reaction in the ZE 25

Temperature profile: −/150/160/200/200/210/210/210° C.

Rotation rate: about 100 rpm,

Addition: 1.5 phr of Dynasylan® SILFIN 24 (CS/V039/08)

b) Kneading Processes

For the production of the masterbatch, 49.0 g of PE were kneaded in a HAAKE laboratory kneader with 1.0 g of catalyst, organic acid, or silicon-containing precursor compound.

Processing parameters:

Kneader, feed hopper, tape die, tape take-off; filled feed zone,

Rotation rate: 30 rpm,

Temperature profile: 200° C./5 min

c) Production of Mixture made of 95% by Weight of Silfin 24 HDPE with 5% by Weight of Masterbatch

A mixture made of 95% by weight of Silfin 24 HDPE with 5% by weight of the masterbatch comprising the catalyst is produced. Processing took place in a HAAKE laboratory kneader. A mixture made of 95% by weight of Silfin 24 HDPE mixture with 5% by weight of masterbatch is kneaded, then pressed at 200° C. to give sheets, and finally crosslinked in a waterbath at 80° C.

Processing parameters:

Kneader, feed hopper, tape die, tape take-off; filled feed zone,

Rotation rate: 30 rpm,

Temperature profile: 140° C./3 min; 2 min up to 210° C.; 210° C/5 min

Crosslinking time: 0 h, 4 h, and 22 h

### Example 11

### Crosslinking of silane-grafted HDPE

Polyethylene was modified chemically (grafted, rotation rate: 30 rpm, temperature profile: 3 min at 140° C., 2 min from 140° C. to 200° C., 10 min 200° C.) with various vinylsilanes with addition of peroxide in a HAAKE data-gathering kneader. Once the graft reaction had been concluded, aluminum trihydroxide (ATH) was added to the kneader as water donor. The presence of postcrosslinking detectable by way of a marked increase in torque was checked. The following mixtures were used:

TABLE 2
Experimental mixtures

| | Dynasylan ® | Vinyltripalmitic | Vinyltricapric |
|---|---|---|---|
| | VTMO | acid silane | acid silane |
| BCUP (tert-butyl | ~0.1 g | ~0.14 g | ~0.1 |
| cumyl peroxide) | | | |
| Respective | ~0.55 g | ~1.1 g | ~1.3 |
| silane-containing | | | |
| compound | | | |

| | |
|---|---|
| HDPE | 50 g |
| ATH | 2 g |

Both experiments using vinyltricarboxysilanes revealed a marked increase in torque after addition of the ATH. The increase was considerably more marked than with vinyltrimethoxysilane. The conclusion from this is that the extent of crosslinking reaction is greater.

### Example 12

### Crosslinking of HDPE—Comparison of vinyltripalmitic acid silane with Dynasylan® SILFIN 06

For this study, the individual crosslinking preparations were admixed with the HDPE power and processed in the kneader (rotation rate: 35 rpm, temperature profile: 2 min at 150° C., in 3 min from 150 to 210° C., 5 min at 210° C.). Table 3 lists the formulations:

TABLE 3
Formulation

| | Vinyltripalmitic acid silane |
|---|---|
| DCUP (dicumyl peroxide) | 0.025 g |
| Silane-containing compound | 1.5 g |
| HDPE | 50 g |

The kneaded specimen was pressed to give a sheet and then crosslinked at 80° C. in the waterbath. The gel content of the crosslinked specimens was measured after various storage times.

TABLE 4
Gel contents of crosslinked specimens

| | | Gel content for |
|---|---|---|
| Crosslinking time | | vinyltripalmitic |
| Waterbath, 80° C. | | acid silane [%] |
| 0.5 | h | 32 |
| 1 | h | 32 |
| 2 | h | 31 |
| 4 | h | 33 |
| 24 | h | 31 |

### Example 13

### Masterkit (Masterbatch)

The carboxysilanes produced were used as catalysts in the sioplas process. For this, 95% by weight of a polyethylene grafted with Dynasylan® SILFIN 24 were kneaded with 5% by weight of the catalyst concentrate (catMB) of the invention. First, a masterbatch was produced with 1 g of the respective catalyst and 49 g of HDPE in the kneader (temperature profile: 5 min at 200° C.). 2.5 g of this were then kneaded together with 47.5 g of the extruded Dynasylan® SILFIN 24 HDPE (temperature profile: 3 min at 140° C., from 140° C. to 210° C. in 2 min, 5 min at 210° C.), and then pressed at 200° C. to give sheets, and finally crosslinked at 80° C. in the waterbath. The catMB included respectively 2% by weight of the respective catalyst, in particular of the vinyltricarboxysilanes or fatty acids. The results were compared with a mixture without catalyst. The sheets were crosslinked at 80° C. in the waterbath. Table 5 shows the results of this crosslinking study.

TABLE 5
Overview of catalyst study in the sioplas process

| | | Gel content | Gel content |
|---|---|---|---|
| Catalyst/ | Gel content | [%] | [%] |
| experiment | [%] | 4 h at 80° C. | 22 h at 80° C. |
| number | Uncrosslinked | Waterbath | Waterbath |
| Blind value- | 13 | 16 | 34 |
| no cat. | | | |
| Vinyltri- | 17 | 33 | 46 |
| palmitic acid | | | |
| silane | | | |
| Hexadecyltri- | 18 | 40 | 49 |
| palmitic acid | | | |
| silane | | | |
| Vinyltricapric | 23 | 36 | 46 |
| acid silane | | | |
| Hexadecyltri- | 23 | 39 | 45 |
| capric acid | | | |
| silane | | | |

1. A method for catalyzing a silane hydrolysis and/or silanol condensation, comprising:
contacting a silane and/or silanol with at least one silicon comprising precursor compound of an organic acid as a silane hydrolysis catalyst and/or a silanol condensation catalyst.

2. The method according to claim 1, wherein
the at least one silicon comprising precursor compound of an organic acid corresponds to general formula I and/or II
(A)_{z}SiR²ₓ(OR¹)_{4-z-x} (I)
(R¹O)_{3-y-u}(R²)ᵤ(A)_{y}Si-A-Si(A)_{y}(R²)ᵤ(OR¹)_{3-y-u} (II)
wherein
mutually independently, z is 0, 1, 2, or 3, x is 0, 1, 2, or 3, y is 0, 1, 2, or 3, and u is 0, 1, 2, or 3, with the proviso that in the formula I z+x is smaller than or equal to (≦) 3, and in the formula II y+u is independently smaller than or equal to (≦) 2,
A is mutually independently in the formula I and/or II a monovalent olefin group, and A in the form of a divalent moiety in the formula II is a divalent olefin group,
R¹ corresponds, mutually independently, to a carbonyl-R³ group, wherein R³ corresponds to a substituted or unsubstituted hydrocarbon moiety, and
R² corresponds, mutually independently, to a substituted or unsubstituted hydrocarbon group.

3. The method according to claim 1, wherein
the at least one silicon comprising precursor compound of an organic acid is applied to a carrier material, or encapsulated and/or embedded into the carrier material.

4. The method according to claim 1, the contacting is in a monosil process, in a sioplas process, and/or in a copolymerization.

5. The method according to claim 1,
wherein
the silicon comprising precursor compound of an organic acid is employed in a monosil process, or a sioplas process with at least one thermoplastic parent polymer or in a copolymerization process with at least one monomer and/or prepolymer of the at least one thermoplastic parent polymer, in the presence of at least one free-radical generator.

6. The method according to claim 1, wherein at least one unfilled Si-crosslinked compounded polymer material and/or at least one filled Si-crosslinked compounded polymer material, and/or corresponding filled Si-crosslinked polymer or unfilled Si-crosslinked polymer comprising at least one thermoplastic parent polymer is produced.

7. The method according to claim 1,
carried out in the presence of a thermoplastic parent polymer, a silane-grafted parent polymer, or a silane-copolymerized parent polymer, and/or in the presence of a monomer and/or prepolymer of said parent polymers.

8. The method according to claim 1, carried out together with an organofunctional silane compound.

9. The method according to claim 8, wherein
the organofunctional silane compound corresponds to an unsaturated alkoxysilane, represented by general formula III
(B)_{b}SiR⁴ₐ(OR⁵)_{3-b-a} (III)
wherein
mutually independently, b is 0, 1, 2, or 3, and a is 0, 1, 2, or 3, with the proviso that in the formula III b+a is smaller than or equal to (≦) 3,
B, mutually independently, is a monovalent (R⁷)₂C═C(R⁷)-E_{q}- group in the formula III, wherein R⁷ are identical or different, and R⁷ is a hydrogen atom or a methyl group or a phenyl group, the group E is a group selected from the group consisting of —CH₂—, —(CH₂)₂—, —(CH₂)₃—, —O(O)C(CH₂)₃—, and —C(O)O—(CH₂)₃—, q is 0 or 1, or isoprenyl, hexenyl, cyclohexenyl, terpenyl, squalanyl, squalenyl, polyterpenyl, betulaprenoxy, cis/trans-polyisoprenyl, or corresponds to an R⁶-Dₚ-[C(R⁶)═C(R⁶)—C(R⁶)═C(R⁶)]ₜ-Dₚ- group, wherein R⁶ are identical or different, and R⁶ is a hydrogen atom or an alkyl group having from 1 to 3 carbon atoms, or an aryl group, or an aralkyl group, or a methyl group or a phenyl group, groups D are identical or different, and D is a group selected from the group consisting of —CH₂—, —(CH₂)₂—, —(CH₂)₃—, —O(O)C(CH₂)₃—, and —C(O)O—(CH₂)₃—, and p is 0 or 1, and t is 1 or 2,
R⁵ is, mutually independently, methyl, ethyl, n-propyl, and/or isopropyl, and
R⁴ is, mutually independently, a substituted or unsubstituted hydrocarbon group.

10. The method according to claim 1, carried out together with at least one other silanol condensation catalyst selected from the group consisting of dibutyltin dilaurate, dioctyltin dilaurate, dioctyltin di(2-ethylhexanoate), dioctyltin di(isooctylmercaptoacetate), dibutyltin dicarboxylate, monobutyltin tris(2-ethylhexanoate), dibutyltin dineodecanoate, laurylstannoxane, dibutyltin diketonoate, dioctyltin oxide, dibutyltin diacetate, dibutyltin maleate, dibutyltin dichloride, dibutyltin sulfide, dibutyltin oxide, an organotin oxide, monobutyltin dihydroxychloride, a monobutyltin oxide, and dibutyltin bis(isooctylmaleate).

11. A product, a molding, a cable, or a pipe, produced by the method according to claim 1.

12. A masterbatch, comprising:
at least one silicon comprising precursor compound of an organic acid and one free-radical generator.

13. A masterbatch comprising wherein
(i) at least one silicon comprising precursor compound of an organic acid of formula I and/or II,
(A)_{z}SiR²ₓ(OR¹)_{4-z-x} (I)
(R¹O)_{3-y-u}(R²)ᵤ(A)_{y}Si-A-Si(A)_{y}(R²)ᵤ(OR¹)_{3-y-u} (II)
wherein
mutually independently, z is 0, 1, 2, or 3, x is 0, 1, 2, or 3, y is 0, 1, 2, or 3, and u is 0, 1, 2, or 3, with the proviso that in the formula I z+x is smaller than or equal to (≦) 3, and in the formula II y+u is independently smaller than or equal to (≦) 2,
A is mutually independently in the formula I and/or II a monovalent olefin group, and A in the form of a divalent moiety in the formula II is a divalent olefin group,
R¹ corresponds, mutually independently, to a carbonyl-R³ group, wherein R³ corresponds to a substituted or unsubstituted hydrocarbon moiety, and
R² corresponds, mutually independently, to a substituted or unsubstituted hydrocarbon group,
(ii) optionally one free-radical generator, and
(iii) optionally one organofunctional silane compound, or one unsaturated alkoxysilane, of formula III,
(B)_{b}SiR⁴ₐ(OR⁵)_{3-b-a} (III)
wherein
mutually independently, b is 0, 1, 2, or 3, and a is 0, 1, 2, or 3, with the proviso that in the formula III b+a is smaller than or equal to (≦) 3,
B, mutually independently, is a monovalent (R⁷)₂C═C(R⁷)-E_{q}- group in the formula III, wherein R⁷ are identical or different, and R⁷ is a hydrogen atom or a methyl group or a phenyl group, the group E is a group selected from the group consisting of —CH₂—, —(CH₂)₂—, —(CH₂)₃—, —O(O)C(CH₂)₃—, and —C(O)O—(CH₂)₃—, q is 0 or 1, or isoprenyl, hexenyl, cyclohexenyl, terpenyl, squalanyl, squalenyl, polyterpenyl, betulaprenoxy, cis/trans-polyisoprenyl, or corresponds to an R⁶-Dₚ[C(R⁶)═C(R⁶)—C R⁶)═C(R⁶)]ₜ-Dₚ- group, wherein R⁶ are identical or different, and R⁶ is a hydrogen atom or an alkyl group having from 1 to 3 carbon atoms, or an aryl group, or an aralkyl group, or a methyl group or a phenyl group, groups D are identical or different, and D is a group selected from the group consisting of —CH₂—, —(CH₂)₂—, —(CH₂)₃—, —O(O)C(CH₂)₃—, and —C(O)O—(CH₂)₃—, and p is 0 or 1, and t is 1 or 2,
R⁵ is, mutually independently, methyl, ethyl, n-propyl, and/or isopropyl,
R⁴ is, mutually independently, a substituted or unsubstituted hydrocarbon group,
and at least one of the above components A, B, and/or C is on a carrier or has been encapsulated.

14. The masterbatch as claimed in claim 12, further comprising
a thermoplastic parent polymer, a silane-grafted parent polymer, a silane-copolymerized parent polymer, and/or monomer, and/or prepolymer, of said parent polymers, and/or a mixture of these.

15. The method according to claim 2, wherein the precursor compound of an organic acid is of the formula I and/or II, and
wherein the contacting is in a monosil process, in a sioplas process, or in a copolymerization process.

16. The method according to claim 2, wherein the precursor compound of an organic acid is of the formula I and/or II
a silicon-containing polymer, or compounded polymer material, or of an unfilled crosslinked polymer, and/or of a filled crosslinked polymer is produced.

17. A product comprising the silicon precursor compound of an organic acid and/or a product of the hydrolysis and/or condensation thereof, according to claim 1.

18. The method according to claim 2, wherein R¹ corresponds, mutually independently, to the carbonyl-R³ group, wherein R³ corresponds to the substituted or unsubstituted hydrocarbon moiety having from 1 to 45 carbon atoms.
